(19) United States
(12) Patent Application Publication
(10) Pub. No.: US 2010/0265729 A1
(43) Pub. Date: Oct. 21, 2010

(54) RED LIGHT IDENTIFICATION COATED LENS AND CAR-USED RED LIGHT IDENTIFICATION SYSTEM USING THE SAME

(76) Inventor: Wan-Hsiang Huang, Taipei City (TW)

Correspondence Address: Wan-Hsiang Huang, 235 Chung - Ho, Box 8-24, Taipei, 235, TW

(21) Appl. No.: 12/426,965

(22) Filed: Apr. 21, 2009

(51) Int. Cl. B60Q 1/26; F21V 5/00

(52) U.S. Cl. 362/487; 362/520

(57) ABSTRACT

A red light identification coated lens has a lens body and a coating film. The coated lens filters light with wavelength of 380 to 600 nm with a transmission ratio of 10 to 50% and passing red light fully. Moreover, a car-used red light identification system is provided, which is suitable for rainy day or fog day and comprises: at least one red light source arranged to a car; and at least one coated lens as above said. Red light has a long wavelength and low reflection rate so that red light can passes through the water drops easily with very low reflection, low scattering and low deflection. Thereby, when a driver wears the coated lens of the present invention, he (or she) can see the image of red light clearly.

### FIELD OF THE INVENTION

The present invention relates to coated lens, and particularly to a coated lens having a lens body and a coating film; wherein the coated lens filters light of wavelength from 380 nm to 600 nm with a transmission ratio of 10 to 50% and passing red light fully, that is, red light with wavelengths between 600 nm to 760 nm passes through the coated lens with a transmission rate of 100%. Moreover, the present invention provides a car-used red light identification system used with a vehicle and suitable for rainy day or fog day; the system comprises at least one red light source arranged on a car body; and at least one coated lens as above said.

### BACKGROUND OF THE INVENTION

In dense fog or rainy day, the light will be dispersed for water drops, or light from the car lights will reflect from the water drops so that the visual feeling of the driver becomes worse. As a result, car accidents will occur.

To resolve above mentioned problem, fog lamps are installed in a car. Generally, the fog lamp emits yellow light which has a longer wavelength so that the light can transmit through the water drops to provide a clear image to drivers. Generally, the fog lamp has the function of light scatting and focusing. The scattering effect will disperse the light to be parallel so as to illuminate the objects in front of the car, while focusing function makes the incident light is focused to provide a better visual effect. However practically, the effect of the fog lamp is limited. Moreover, the light from the fog lamp will make the driver's visual feeling for another car moving in opposite side becomes worse. As a result traffic safety is affected.

It is known that from the viewpoint of the society, the fog lamp is not a better device for traffic safety. Therefore, more and more nations limit the use of fog lamp, even some nations prohibit to use fog lamp as an illumination device.

Thus there is an eager demand for a novel design which can improve the prior art defect so as to provide a clear image to drivers in rainy day or fog day, but not affect the visual feeling of other drivers.

### SUMMARY OF THE INVENTION

Accordingly, the object of the present invention is to provide a novel coated lens which passes red light wholly, while hinders some part of the visual light so as to make the drivers have better visual feeling. The drivers must wear a special made lens for viewing the images radiated by red light, while the visual feeling of other drivers at the opposite side will not be affected. Thus the shortcoming from the conventional fog lamps is avoided. Therefore, the present invention provides a better device for replacing the conventional fog lamp.

To achieve above object, the present invention provides a coated lens having a lens body and a coating film; wherein the coated lens filters light with wavelength of 380 to 600 nm with a transmission ratio of 10 to 50% and passing red light fully, that is, red light with wavelengths between 600 nm to 760 nm passes through the coated lens fully with a transmission rate of 100%.

Moreover, the present invention provides a car-used red light identification system suitable for rainy day or fog day comprising: at least one red light source arranged to a car; at least one coated lens having a lens body and a coating film; wherein the coated lens filters light with wavelength of 380 to 600 nm with a transmission ratio of 10 to 50% and passing red light fully, that is, red light with wavelengths between 600 nm to 760 nm passes through the coated lens fully with a transmission rate of 100%. The red light source is arranged on a car light original arranged on a car or is independent to the car light original arranged on a car. The red light source is arranged at a front side, rear side or lateral side of a car. At least one control wire has one end connected to the red light source and another end of the control wire is connected to a control switch which is controllable by a car driver.

### BRIEF DESCRIPTION OF THE DRAWINGS

FIG. 1 is a drawing showing the transmittance of the coated lens of the present invention.

FIG. 2 is a schematic view showing the spectrum of the visual light of the present invention.

FIG. 3 shows the light strength after white light passes through the coated length of the present invention.

FIG. 4 shows that a red light source is arranged at a front side of a car according to the present invention.

FIG. 5 shows that a red light source is arranged within the original light seat of a car.

FIG. 6 shows that a red light source is arranged at a rear side of a car according to the present invention.

FIG. 7 shows that a red light source is arranged at a lateral side of a car according to the present invention.

FIG. 8 shows that a plurality of red light sources are arranged at different areas of a car according to the present invention.

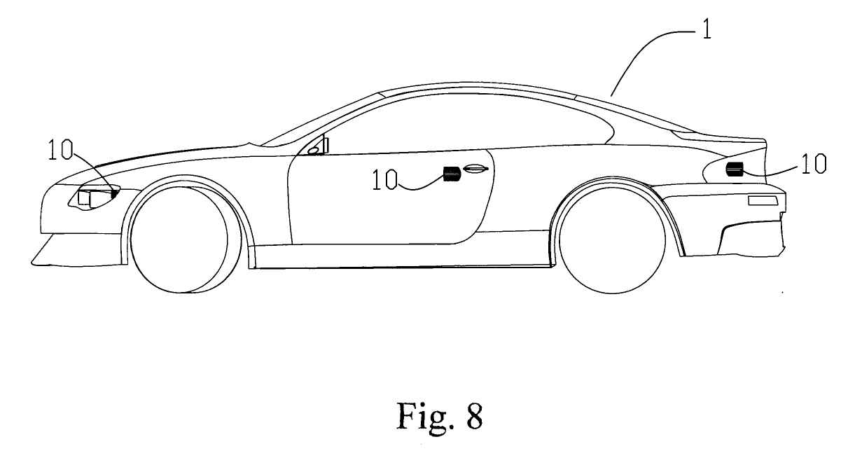

FIG. 9 shows that when a plurality of red light sources are arranged on an outer side of car, the control wires of these red light sources are arranged to the control panel of the driver.

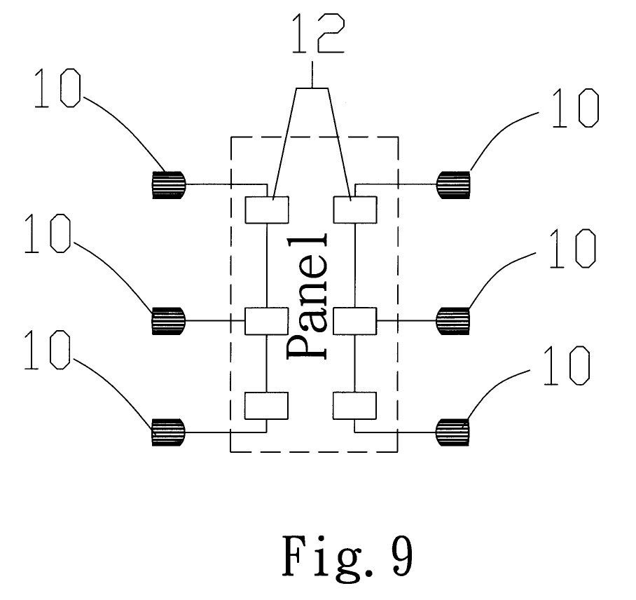

FIG. 10 shows the structure of the coated lens of the invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

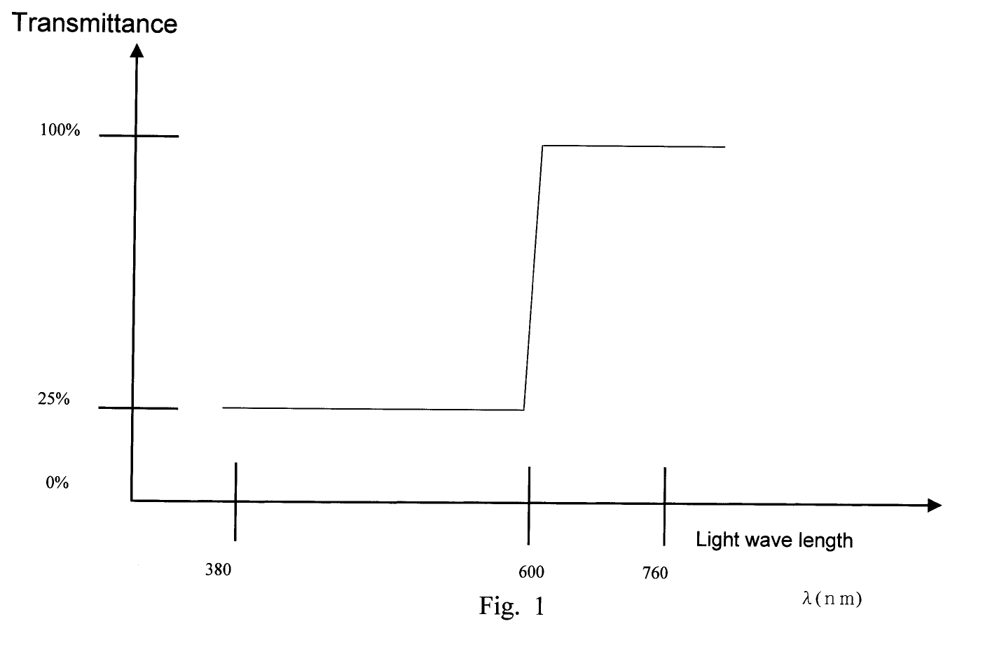

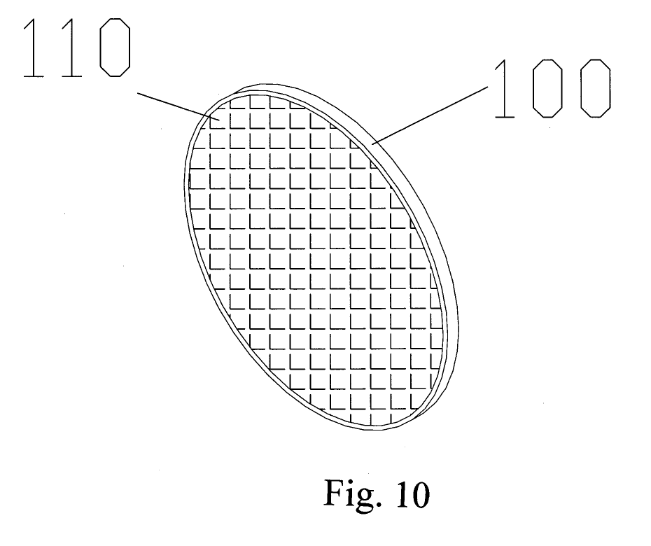

A coated lens which filters light with 380 to 600 nm with a transmission ratio of 10 to 50% and passes red light fully, that is, red light (λ=600 nm˜760 nm) passes through the coated lens fully with a transmission rate of 100% (referring to FIG. 1). Red light has a long wavelength and low reflection rate so that red light can passes through the water drops easily with very low reflection, low scattering and low deflection. Thereby, when a driver wears the coated lens of the present invention, he (or she) can see the image of red light clearly since other visible light has been reduced. Other visible light is not fully filtered so that the driver can view traffic light, for example, green light with wavelength of λ(=500˜570 nm) and yellow light with wavelength of λ(=570˜590 nm) can pass through the lens. The transmission rate of the visible light other than red light is varied with the human race. One example of the coated lens is illustrated in FIG. 10, in that, a lens 100 is made of glass and the lens 100 is coated with a film formed by the TiO2 or SiO2.

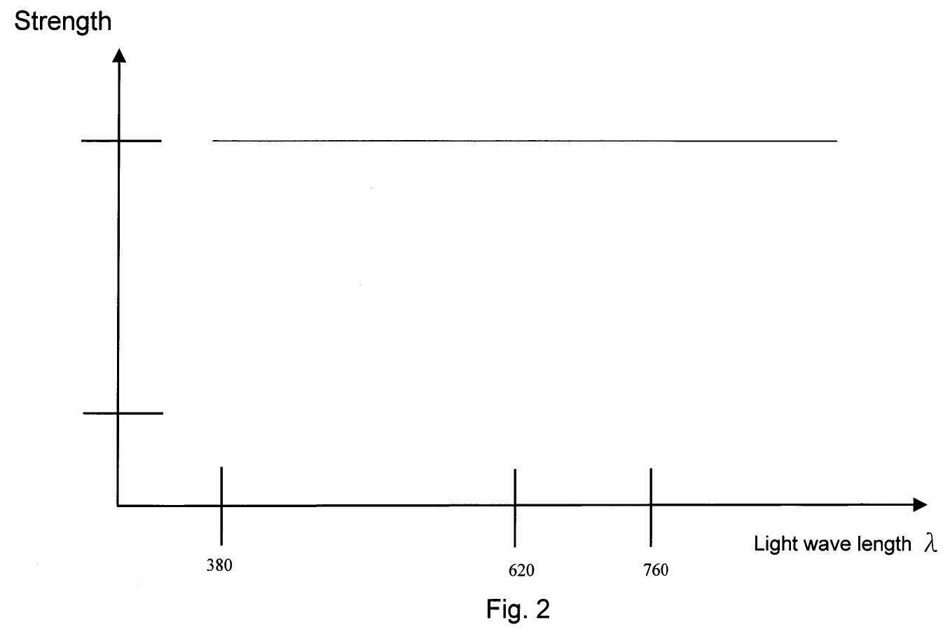

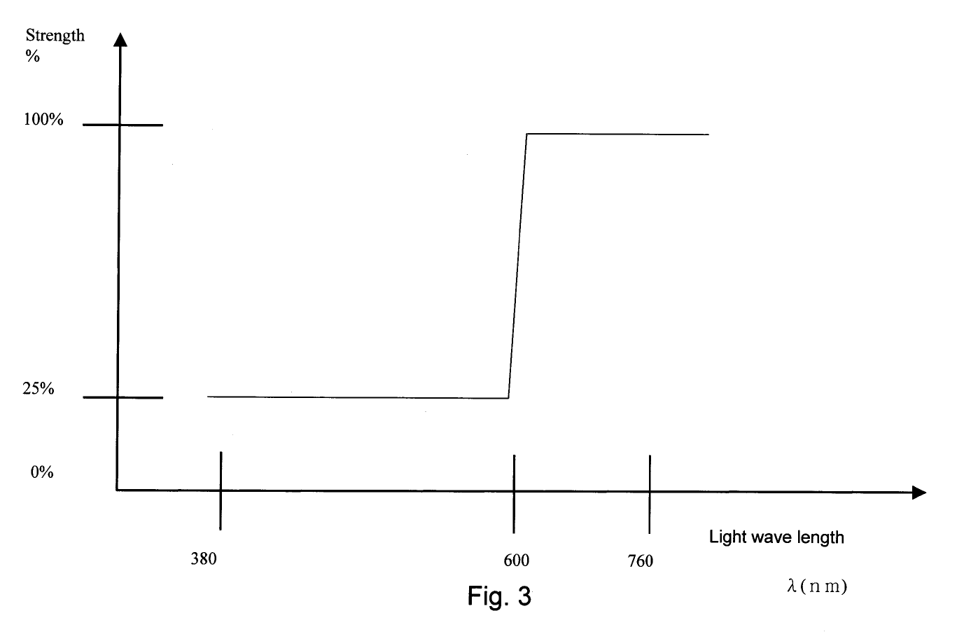

Referring to FIGS. 1, 2, and 3, FIG. 1 shows the transmission rate curve of the present invention. FIG. 2 shows the spectrum for visible light from sun. FIG. 3 shows the spectrum of visible light after passing through the coated lens of the present invention. It is seen that most visible light other than red light is filtered, while red light full passes through the coated lens of the present invention. Thus, the lens of the present invention causes that the driver can view the outside image clearly in rainy day or fog day.

The red light coated lens of the present invention has a preferred effect than the prior art yellow light image.

The present invention can be used with a red light system equipped on a car. The structure has the following elements.

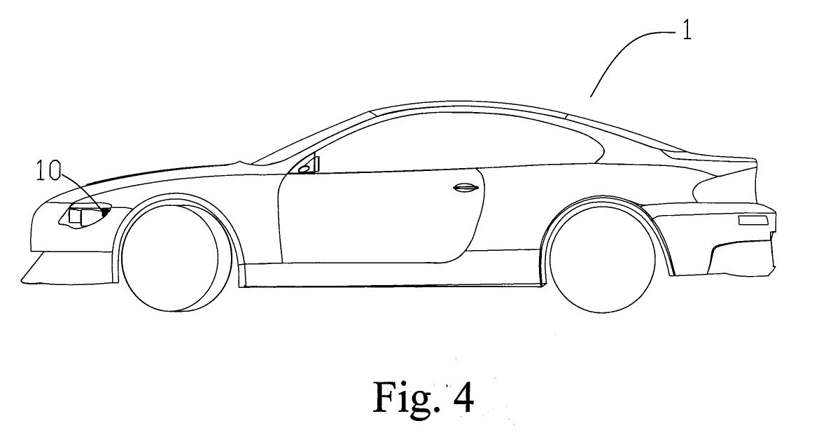

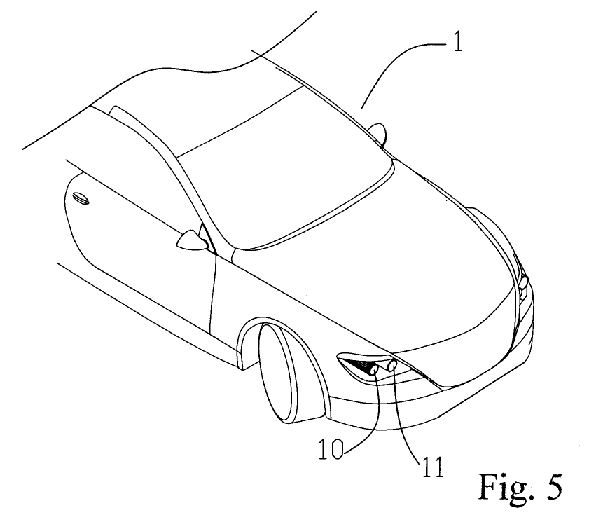

At least one red light source 10, such as LED red light source. Referring to FIG. 5, the red light can be equipped with a light source 11 original equipped on the car, such as a front light of a car, or the red light source 10 is an independent light source, as illustrated in FIG. 4. In FIG. 4, it is illustrated the red light source 10 is installed at a front side of the car for illuminating area in front of the car clearly.

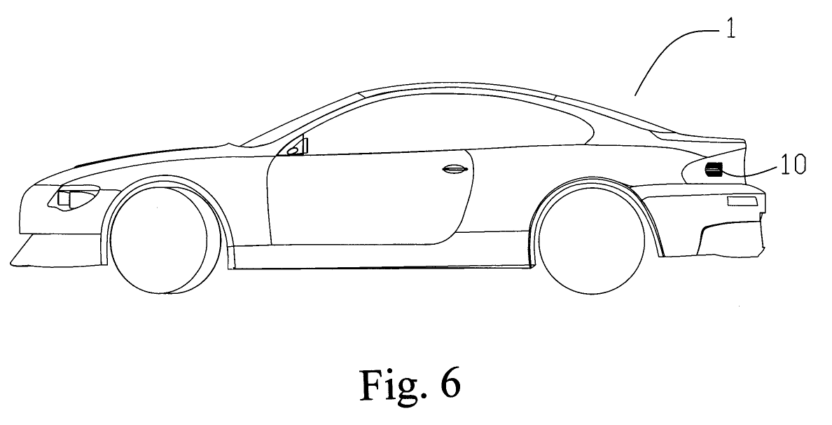

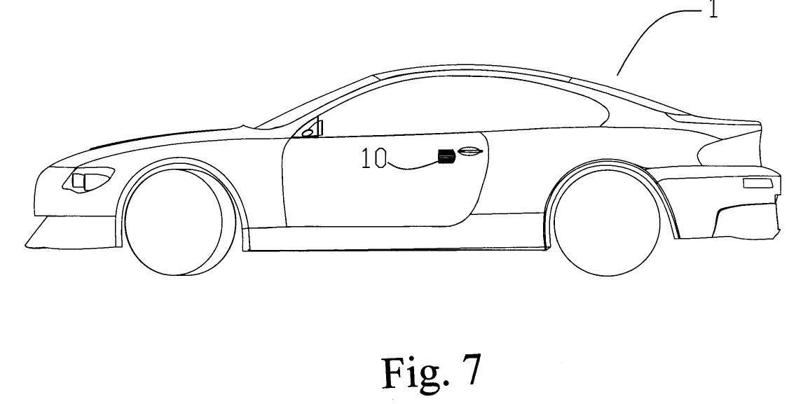

In the present invention, referring to FIG. 6, it is illustrated that the red light source is installed at a rear side of the car for illuminating where behind the car, or the red light source 10 is installed at a lateral side of a car (as shown in FIG. 7). All these are within the scope of the present invention.

Since the red light source 10 has a longer wavelength with a minimum deflection in visible light so that when the red light passes through rain, it is a very small deflection and has a great reflection from a object so that when a driver wearing the coated lens of the present invention, he can see the image clearly without effect by rain or fog. The effect is better than daylight.

In the present invention, the switch of the red light source 10 can be identical to the original car lights or different from the original car lights.

When the red light source 10 has identical controlled switch as the original car light, the switch of the red light source 10 is identical to the original light source 11. If the red light source 10 is equipped at a front side of a car, as the front light of the car lights up, the red light source 10 also lights up. If the front light distinguishes, the red light source 10 also distinguishes. The operation is identical as the red light source is installed at other places.

Generally, the front lights and tail lights of a car have provided some red light to the driver, and thus red lights can be only installed at the two lateral sides of a car, such as using red light LED. To have a better effect, the front side of a car can be additionally installed with red lights. This is helpful in rainy day or in fog day.

In the present invention, the system includes at least control wire which is connected to the red light source. One end of the control wire is connected to a control wire and another end thereof is connected to the red light source so that the driver can turn on or turn off the red light source. Thus the view of the driver is not affected by the original car illuminating system. As illustrated in FIG. 6, if a plurality of red light sources are arranged, all the control wires can be concentrated in the driver's control panel so as a switch center 12.

Advantages of the present invention are that the coated lens for passing red light and hindering other visible light can make the driver has clear images in rainy day or in fog day. Furthermore, the coated lens of the present invention can be used with red light source on a car so as to replace the prior art fog lamp.

The red light source has a better effect than the conventional fog lamp, which causes the driver has a better visual feeling with clear input images. The present invention is more suitable for rainy day or fog day.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A red light identification coated lens having a lens body and a coating film; wherein the coated lens filters light of wavelength from 380 nm (nanometers) to 600 nm with a transmission ratio of 10 to 50% and passing red light fully, that is, red light with wavelengths between 600 nm to 760 nm passes through the coated lens with a transmission rate of 100%.

2. A car-used red light identification system suitable for rainy day or fog day comprising:
at least one red light source arranged to a car;
at least one coated lens having a lens body and a coating film; wherein the coated lens filters light of wavelength from 380 nm to 600 nm with a transmission ratio of 10 to 50% and passing red light fully, that is, red light with wavelengths between 600 nm to 760 nm passes through the coated lens with a transmission rate of 100%.

3. The car-used red light identification system as claimed in claim 2, wherein the red light source is arranged on a car light original arranged on a car.

4. The car-used red light identification system the red light source is independent to the car light original arranged on a car.

5. The car-used red light identification system as claimed in claim 2, wherein the red light source is arranged at a front side of a car.

6. The car-used red light identification system as claimed in claim 2, wherein the red light source is arranged at a rear side of a car.

7. The car-used red light identification system as claimed in claim 2, wherein the red light source is arranged at a lateral side of a car.

8. The car-used red light identification system as claimed in claim 2, wherein at least one control wire has one end connected to the red light source and another end of the control wire is connected to a control switch which is controllable by a car driver.
